(19) United States
(12) Patent Application Publication
(10) Pub. No.: US 2015/0103987 A1
(43) Pub. Date: Apr. 16, 2015

(54) METHOD AND SYSTEM FOR GENERATING DIGITAL EVENTS FOR ANALOG PHONE SYSTEMS

(71) Applicant: CallFire, Inc., Santa Monica, CA (US)

(72) Inventors: William Shane Blaser, Santa Rosa Valley, CA (US); Komnieve Singh, Los Angeles, CA (US)

(21) Appl. No.: 14/514,126

(22) Filed: Oct. 14, 2014

Related U.S. Application Data
(60) Provisional application No. 61/891,721, filed on Oct. 16, 2013.

(51) Int. Cl. H04M 3/22; H04M 3/42

(52) U.S. Cl. CPC H04M 3/2218; H04M 3/42042; H04M 2250/60; H04M 2207/203
USPC 379/93.23

(57) ABSTRACT

A method for generating digital events in response to inbound or outbound phone calls on analog phone systems is described. The method monitors a public switched telephone network (PSTN) phone line to detect a call. The analog audio signal of the detected call is amplified. The method acquires call information regarding the detected call from the phone line. The call information is sent to a server as a digital event over a network interface. Voice call recording for the call is initiated. The method uploads a data record that contains the voice call recording to the server over the network interface after the completion of the call. Other embodiments are also described and claimed.

### RELATED APPLICATIONS

This application claims the benefit of the earlier filing date of U.S. Provisional Application No. 61/891,721 filed Oct. 16, 2013, entitled “Method and Apparatus for Generating Call Events for Analog Telephone Systems”.

### FIELD OF THE INVENTION

The embodiments of the invention relate to a method and system for generating digital events in response to inbound or outbound phone calls on analog phone systems.

### BACKGROUND

Large scale businesses can install and utilize digital phone systems that integrate into customer databases and services. Using digital phone systems enables integration with other information technology systems of the large scale business. The integration can include integration between the digital phone system and enterprise software including data bases, business application and similar systems. This enables, for example, an employee to receive or start a phone call with a customer that is detected by the digital phone system and integrated with the enterprise services of the business that can include the automated retrieval of customer history, call history, purchase history and similar information that enables the employee to quickly access relevant information to service the needs of the customer during the phone call. These systems are expensive to implement and out of reach for many small businesses.

Small businesses often utilize analog phone systems that cannot be easily and affordably integrated with any customer related databases or enterprise software. The inbound and outbound call information is in an analog signal that is only accessible to analog telephones and some caller identification devices that are able to decode caller identification information that may be encoded in the analog signal. However, these caller identification devices and analog telephones have no facility to interconnect with the customer related database or enterprise software. The employee receiving or generating a call to a customer must independently access the databases and enterprise software by data input through a personal computer or similar device. This process is slow and can diminish the customer experience when the employee must spend considerable time looking up relevant information for the customer.

### SUMMARY

An embodiment of the disclosure is a method that generates digital events in response to inbound or outbound phone calls on analog phone systems. In an exemplary embodiment, the method monitors a public switched telephone network (PSTN) phone line to detect a call. The analog audio signal of the detected call is amplified. The method acquires call information regarding the detected call from the phone line. The call information is sent to a server as a digital event over a network interface. Voice call recording for the call is initiated. The method uploads a data record that contains the voice call recording to the server over the network interface after the completion of the call.

In one embodiment, the call is detected by detecting analog audio activity indicating a dial tone and/or dual tone multi-frequency (DTMF) tones of an outbound call. In one embodiment, the call is detected by detecting analog audio activity indicating the signal of an inbound call. In one embodiment, the call information includes the phone number of an inbound or outbound call. In one embodiment, the call information includes caller identification information of the inbound call. In one embodiment, the data record of the call includes a recording of the call, a direction of the call, and a phone number of the inbound or outbound call. In one embodiment, the phone number of the inbound call is demodulated from caller identification information of the call and the phone number of the outbound call is demodulated from the DTMF tones of the call.

An embodiment of the disclosure is a device that generates digital events in response to inbound or outbound phone calls on analog phone systems. The device includes an audio board and a signal processing board. The audio board receives an analog audio activity over a phone line. The signal processing board monitors the phone line with the analog audio activity to detect a call. The signal processing board acquires call information regarding the call from the phone line. The signal processing board sends the call information to a server as a digital event. The signal processing board uploads a call detail record of the call to the server after call completion. In one embodiment, the call detail record includes a recording of the call, a direction of the call, and a phone number of inbound or outbound call.

The above summary does not include an exhaustive list of all aspects of the invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram of one embodiment of a system for generating digital events based on analog phone calls.

FIG. 2 is a flowchart of one embodiment of the processing of analog signals on the customer local loop by the digital event generator.

FIG. 3 is an example of a client interface of one embodiment that displays call information regarding a particular phone number.

FIG. 4 is an example of a client interface of one embodiment that displays detailed call information.

FIG. 5 is an example of a client interface 500 of one embodiment that displays detailed call information and performs analysis on call information.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

The techniques shown in the figures can be implemented using code and data stored and executed on one or more electronic devices (e.g., specialized consumer electronic devices, computers, servers, cellular phones, tablet computers, netbooks and similar devices). Such electronic devices store and communicate (internally and/or with other electronic devices over a network) code and data using non-transitory machine-readable or computer-readable media, such as non-transitory machine-readable or computer-readable storage media (e.g., magnetic disks, optical disks, random access memory, read only memory, flash memory devices, and phase-change memory).

In addition, such electronic devices typically include a set of one or more processors coupled to one or more other components, such as one or more storage devices, user input/output devices (e.g., a keyboard, a touch screen, and/or a display), and network connections. The coupling of the set of processors and other components is typically through one or more busses and bridges (also termed as bus controllers). The storage devices represent one or more non-transitory machine-readable or computer-readable storage media and non-transitory machine-readable or computer-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

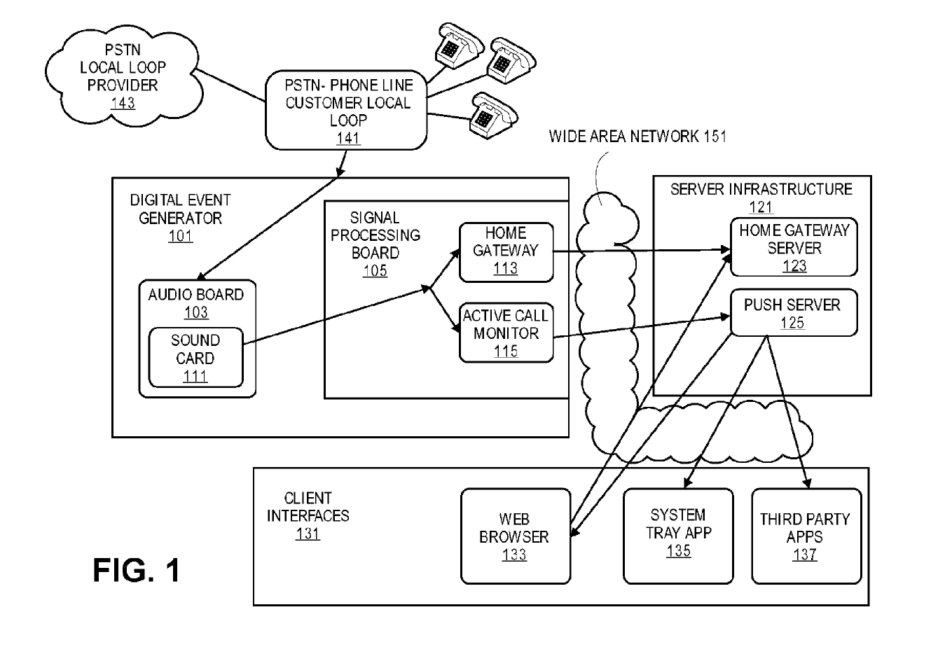

FIG. 1 is a diagram of one embodiment of a system for generating digital events based on analog phone calls. In one embodiment, the system includes a digital event generator 101 that is connected to a public switched telephone network (PSTN) and a wide area network (WAN) 151 or similar communication system. The digital event generator 101 can generate digital events that are sent to a server infrastructure 121 over the WAN 151 or similar network. In turn, the server infrastructure 121 can make available the digital event to client interfaces 131.

The digital event generator 101 can be connected to a PSTN phone jack in a customer local loop 141 in a place of business, residence or similar environment. The digital event generator 101 can be connected to any jack that is connected to the customer local loop 141 that is in turn connected to the local loop provider 143 of the PSTN such that it can monitor the inbound and outbound calls traversing the phone line. The phone lines can be connected to other devices via separate connection jacks or via a pass through in the digital event generator 101.

The digital event generator 101 can include an audio board 103 and a signal processing board 105. In the illustrated example, the signal processing board 105 is a Raspberry Pi board, manufactured by the Raspberry Pi foundation of the United Kingdom. However, the signal processing board 105 can be any set of components that include a general purpose processor or application specific integrated circuit (ASIC) that is configured to process the analog phone line signal to generate digital events as discussed further herein below. In one embodiment, as illustrated, a separate audio board 103 can be included in the digital event generator 101 to extract the audio from a PSTN line, amplify the signal of the phone line to an acceptable level for signal processing, or perform similar conditioning of the signal to prepare it for processing. In one embodiment, the audio board 103 includes a sound card 111 that converts the analog phone line signal to a digital signal. In one embodiment, a transformer is used to extract the audio signal off of the phone line. In one embodiment, the audio signal is amplified to 0.3 v to allow for audio processing.

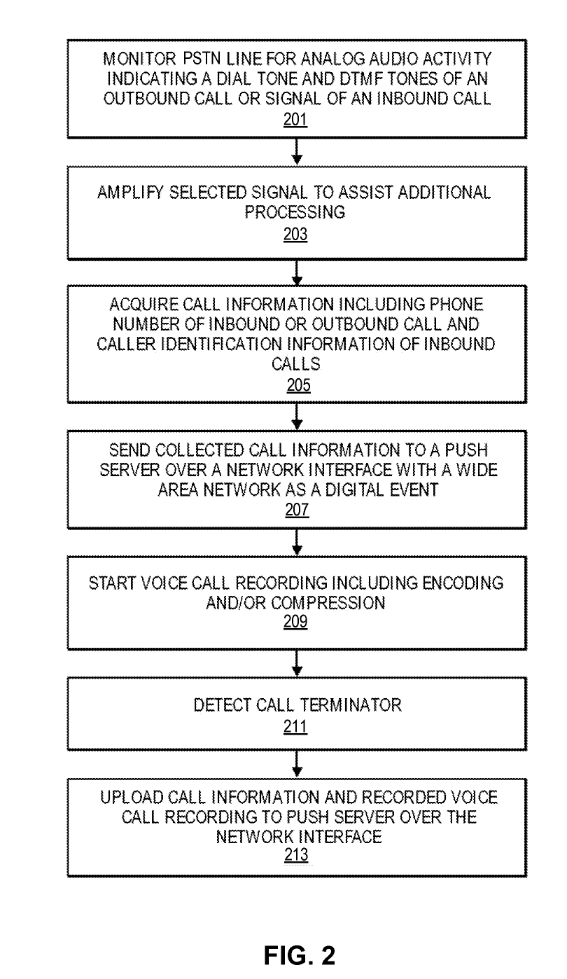

The signal processing board 105 can identify inbound and outbound calls by monitoring the phone line for dial tones, dual tone multi-frequency (DTMF) tones, and similar signals on the phone line. As described further herein below with regard to FIG. 2, the detection of these signals can trigger the generation of a digital event that is sent over the WAN 151 to the server infrastructure 121. The signal processing board 105 can also record call information including the associated phone numbers, the call duration and the voice call itself The voice call can be recorded using any data format suitable for storing voice information such as MP3 or similar format. The signal processing board 105 can include storage devices to record call information and voice information as well as code and similar data to implement the digital event generation system.

The digital event that is sent to the server infrastructure 121 can be a message that is transmitted over the WAN 151 or any communication network using any protocol including the Internet Protocol (IP), transmission control protocol (TCP), user datagram protocol (UDP) or similar protocol. The digital event can have any data or message format. In some embodiments, the digital event will include initial call information such as phone number and/or caller identification information decoded from the analog call. After a call completes, additional information can be uploaded to the server infrastructure 121.

In the illustrated example using a Raspberry Pi implementation, the signal processing board 105 includes a home gateway 113 to record the audio from the call and generate a call data record (CDR) for each active call. In one embodiment, a CDR contains call recording, call direction, incoming phone number (e.g., demodulated from caller identification signal of inbound call), and outbound number (e.g., demodulated from DTMF tones of outbound call). In one embodiment, the home gateway 113 subsequently uploads the call recording and CDR to home gateway server 123 of the server infrastructure 121. An active call monitor 115 can also be implemented to detect the calls, including their source and/or destination, decodes the caller identification information for inbound calls (if present) and DTMF tones for outbound calls, and uploads the digital event to push server 125.

The server infrastructure 121 can be provided by any set of computing devices including dedicates server machines or similar computing devices. The server infrastructure 121 can execute an intermediate service, such as a push server 125 that receives digital events and other call data from any number of digital event generators and stores and associates the digital events with the appropriate server records. The push server 125 allows clients (e.g., web browser, system tray application, and third-party application) to register for call events. Once a client is registered, the push server 125 will send a message to the client each time a call comes in. The server infrastructure 121 can also include a home gate way server 123. The home gateway server 123 can provide browser based web interface to call data, as well as storing and retrieving call CDRs and recordings. The server infrastructure 121 can be operated by the same entity that installs the digital event generators or can be operated by a third party.

The server infrastructure 121 can expose the digital events or ‘push’ or forward (e.g., through the push server 125) these digital events to subscribing client applications and interfaces 131. Example client interfaces and applications that can receive and subscribe to these digital events can include web browsers 133, system tray applications 135, third party applications 137 and similar software. These software applications can be executed by any machine of the entity that has installed the digital event generators. These software applications can include enterprise software and similar business software that can pull customer records from customer databases or perform similar operations in response to receiving the digital events that identify the source and/or destination of a call.

In one embodiment, the system described above for generating digital events based on analog phone calls can be implemented as a set of hardware devices. In another embodiment, the system components are implemented in software (for example microcode, assembly language or higher level languages). These software implementations can be stored on a non-transitory computer-readable medium. A non-transitory “computer-readable” medium can include any medium that can store information. Examples of the computer-readable medium include a read only memory (ROM), a floppy diskette, a CD Rom, a DVD, a flash memory, a hard drive, an optical disc or similar medium.

FIG. 2 is a flowchart of one embodiment of the processing of analog signals on the customer local loop by the digital event generator. In one embodiment, the customer local loop is the customer local loop 141 described in FIG. 1 above, and the digital event generator is the digital event generator 101 described in FIG. 1 above. In one embodiment, the digital event generator monitors the PSTN line for analog audio activity indicating a dial tone and DTMF tones of an outbound call or a signal of an inbound call (Block 201). Detection of such activity can trigger the audio board to amplify the signal to assist in further processing (Block 203). In other embodiments, all signals on the phone line are amplified and the monitoring triggers further processing in response to detection of activity. In one embodiment, the audio board that amplifies signal is the audio board 103 described in FIG. 1 above.

After signal activity is detected, the signal processing board 105 acquires the call information including source and/or destination phone number of the inbound or outbound call and caller identification information of inbound calls (Block 205). In one embodiment, the signal processing board is the signal processing board 105 described in FIG. 1 above. Inbound calls can contain caller identification information that is encoded text providing information about the source of the caller such as an individual's name or company name. This information can be collected and tracked for each active call in the customer local loop, including calls that are on hold or available via call waiting and similar calls. The digital event generator can service any number of separate phone lines and/or phone numbers of the entity that installs the digital event generator. In some embodiments, the digital event generator can physically be tied to multiple lines, while in other embodiments, multiple digital event generators can be used to service any configuration of phone numbers or phone lines.

The initially collected call information can be sent by the digital event generator via a network interface with a WAN to a push server or similar server infrastructure in the form of a digital event (Block 207). In one embodiment, the push server is the push server 125 described in FIG. 1 above, and the server infrastructure is the server infrastructure 121 described in FIG. 1 above. The digital event can contain any subset of the collected call information and can have any format and can be transmitted via any protocol. At the same time or after the transmission of the digital event, the voice call recording can be initiated (Block 209). The voice call can be recorded within the digital event generator using any audio compression or encoding software or protocols. In one example, the voice calls are recorded as MP3 audio files. The device continues to monitor the voice call to detect silence on the line indicating that the call has completed (Block 211).

Once the call has completed, additional call information such as the duration of the call can be uploaded to the push server or server infrastructure along with the recorded audio file (Block 213). This data can be sent over the network interface and via a WAN or similar communication network. The data can be stored separately, in a distributed manner or similarly stored by the server infrastructure. Any subset of the data can be pushed to or exposed to the client interfaces.

In one embodiment, the system can be implemented as a set of hardware devices. In another embodiment, the system components are implemented in software (for example microcode, assembly language or higher level languages). These software implementations can be stored on a non-transitory computer-readable medium. A non-transitory “computer-readable” medium can include any medium that can store information. Examples of the computer-readable medium include a read only memory (ROM), a floppy diskette, a CD Rom, a DVD, a flash memory, a hard drive, an optical disc or similar medium.

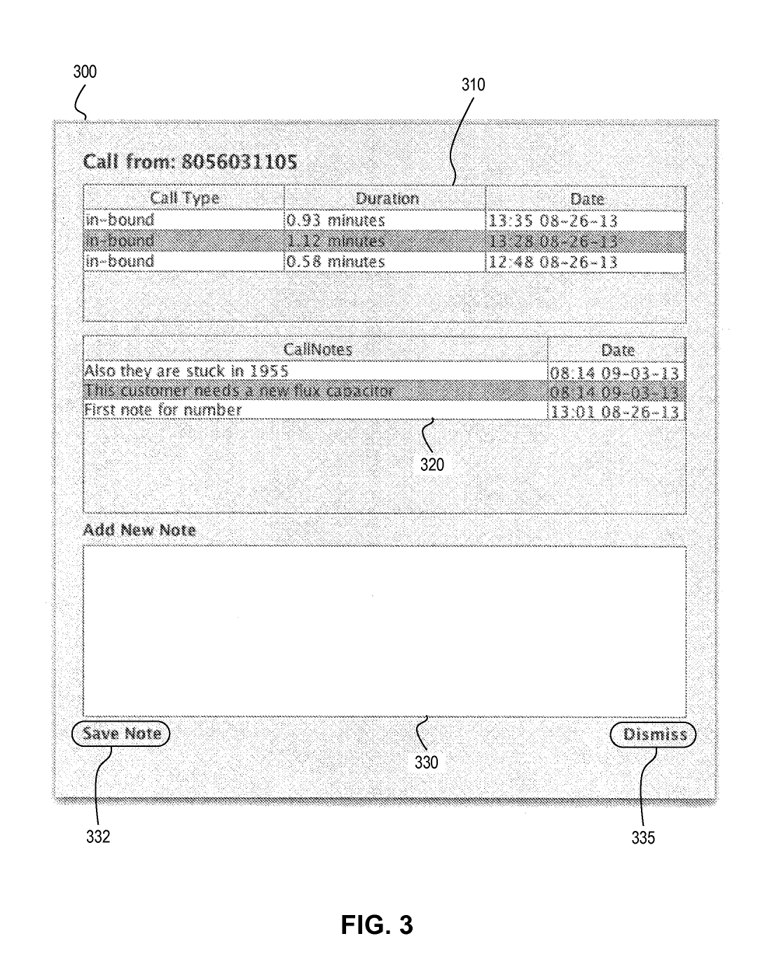

FIG. 3 is an example of a client interface 300 of one embodiment that displays call information regarding a particular phone number. The client interface 300 can be displayed as part of a web browser, a system tray application, or a third-party application. In one embodiment, the related web browser or application is registered with a push server (e.g., the push server 125) described in FIG. 1 above) and the client interface 300 is constantly updated based on the call events received from the push server. As illustrated, the client interface 300 includes a call history area 310, a call notes area 320, and a note generation area 330.

The call history area 310 displays a list of phone calls to or from the particular phone number. For each phone call, information regarding the phone call (e.g., call type, duration, and call initiation time) is displayed. The call type may include inbound call and outbound call. The call notes area 320 displays a list of call notes related to the particular phone number. For each note, the text of the note and the generation time of the note are displayed. The note generation area 330 includes a text box in which a user can edit notes. Once the user finishes editing a note, he/she can select the save-note button 332 to save the note or select the dismiss button 335 to discard the note.

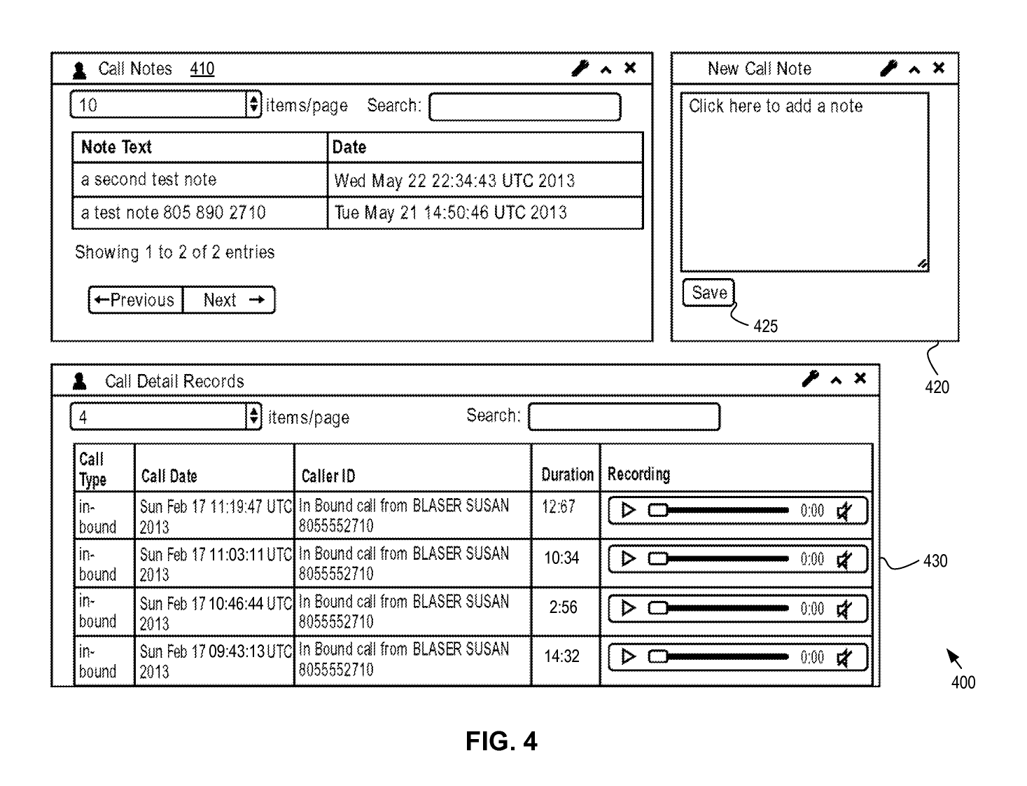

FIG. 4 is an example of a client interface 400 of one embodiment that displays detailed call information. The client interface 400 can be displayed as part of a web browser, a system tray application, or a third-party application. In one embodiment, the related web browser or application is registered with a push server (e.g., the push server 125) described in FIG. 1 above) and the client interface 400 is constantly updated based on the call events received from the push server. As illustrated, the client interface 400 includes a call notes area 410, a note generation area 420, and a call detail records area 430.

The call notes area 410 displays a list of call notes. For each note, the text of the note and the generation time of the note are displayed. The note generation area 420 includes a text box in which a user can edit notes. Once the user finishes editing a note, he/she can select the save button 425 to save the note. The call detail records area 430 displays a list of phone calls to or from the system. For each phone call, detailed information regarding the phone call is displayed. The detailed information regarding a call may include call type, call initiation time, caller identification information of an inbound call, duration, and recording of the call. The call type may include inbound call and outbound call.

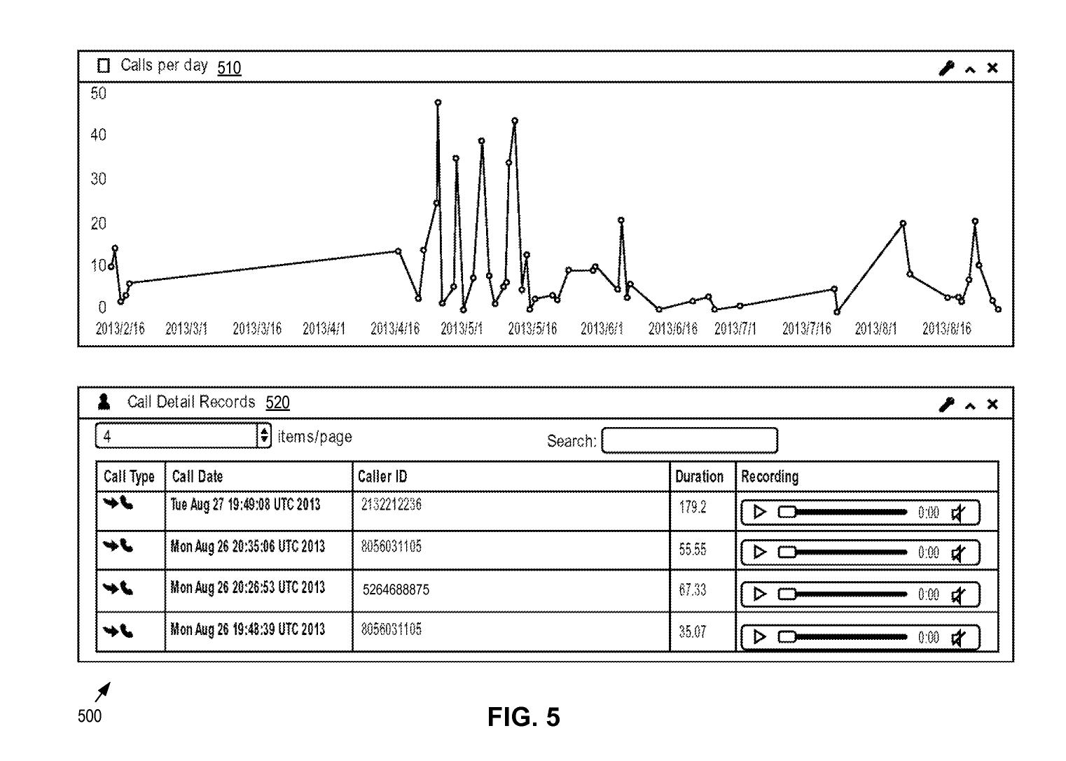

FIG. 5 is an example of a client interface 500 of one embodiment that displays detailed call information and performs analysis on call information. The client interface 500 can be displayed as part of a web browser, a system tray application, or a third-party application. In one embodiment, the related web browser or application is registered with a push server (e.g., the push server 125) described in FIG. 1 above) and the client interface 400 is constantly updated based on the call events received from the push server. As illustrated, the client interface 500 includes a chart area 510 and a call detail records area 520.

The chart area 510 displays a chart as a result of performing analysis on call information. In one embodiment, the related web browser or application performs statistical analysis on call information to generate the chart. For example, the statistical analysis may generate a chart regarding calls per day for a specific period of time, as illustrated in FIG. 5. The call detail records area 520 displays a list of phone calls to or from the system. For each phone call, detailed information regarding the phone call is displayed. The detailed information regarding a call may include call type, call initiation time, caller identification information of an inbound call, duration, and recording of the call. The call type may include inbound call and outbound call.

Thus, a method, system and apparatus for the generation of digital events for analog phone lines has been described. It is to be understood that the above description is intended to be illustrative and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method comprising:
monitoring an analog phone line to detect a call;
acquiring call information regarding the detected call from the analog phone line;
sending the call information to a server as a digital event; and
uploading a data record of the call to the server after completion of the call.

2. The method of claim 1, wherein the analog phone line is a public switched telephone network (PSTN) phone line.

3. The method of claim 1, wherein the call is detected by detecting analog audio activity indicating a dial tone and/or dual tone multi-frequency (DTMF) tones of an outbound call.

4. The method of claim 1, wherein the call is detected by detecting analog audio activity indicating signal of an inbound call.

5. The method of claim 1, wherein the call information comprises phone number of inbound or outbound call.

6. The method of claim 1, wherein the call information comprises caller identification information of inbound call.

7. The method of claim 1, wherein the call information and the data record are sent to the server over a network interface.

8. The method of claim 1, wherein the data record comprises a recording of the call, a direction of the call, and a phone number of inbound or outbound call.

9. The method of claim 8, wherein the phone number of inbound call is demodulated from caller identification information of the call.

10. The method of claim 8, wherein the phone number of outbound call is demodulated from dual tone multi-frequency (DTMF) tones of the call.

11. The method of claim 1 further comprising amplifying analog audio signal of the detected call.

12. The method of claim 1 further comprising initiating voice call recording for the call.

13. The method of claim 1 further comprising detecting termination of the call.

14. A device comprising:
an audio board to receive an analog audio activity over a phone line; and
a signal processing board to monitor the phone line with the analog audio activity to detect a call, acquire call information regarding the call from the phone line, send the call information to a server as a digital event, and upload a call detail record of the call to the server after call completion.

15. The device of claim 14, wherein the signal processing board detects the call by detecting that the analog audio activity indicates a dial tone and/or dual tone multi-frequency (DTMF) tones of an outbound call.

16. The device of claim 14, wherein the signal processing board detects the call by detecting that the analog audio activity indicates signal of an inbound call.

17. The device of claim 14, wherein the call information comprises phone number of inbound or outbound call.

18. The device of claim 14, wherein the call information comprises caller identification information of inbound call.

19. The device of claim 14, wherein the signal processing board sends the call information and the call detail record to the server over a network interface.

20. The device of claim 14, wherein the call detail record comprises a recording of the call, a direction of the call, and a phone number of inbound or outbound call.
